(19) United States
(12) Patent Application Publication
(10) Pub. No.: US 2016/0089781 A1
(43) Pub. Date: Mar. 31, 2016

(54) ROBOT, CONTROL APPARATUS AND ROBOT SYSTEM

(71) Applicant: Seiko Epson Corporation, Tokyo (JP)

(72) Inventor: Takema YAMAZAKI, Fujimi (JP)

(21) Appl. No.: 14/856,975

(22) Filed: Sep. 17, 2015

(30) Foreign Application Priority Data
Sep. 30, 2014 (JP) 2014-200249

(51) Int. Cl. B25J 9/16; B25J 9/00

(52) U.S. Cl. CPC B25J 9/161; B25J 9/0087; B25J 9/0009; Y10S 901/02

(57) ABSTRACT

A robot includes a casing, a first arm unit and a second arm unit provided on the casing, a first board that outputs a current command signal, a second board that controls an actuator for driving the first arm unit based on the current command signal, and a third board that controls an actuator for driving the second arm unit based on the current command signal. The second board and the third board are provided inside of the casing.

### BACKGROUND

1. Technical Field

The present invention relates to a robot.

2. Related Art

Recently, robots that control a plurality of arm units in a coordinated manner like dual-arm robots have attracted attention (see Patent Document 1 (JP-A-2014-664)).

In the robots, when pluralities of arm units and circuit boards are provided in one casing, noise and heat generation may be more problematic than those in robots of related art in which arm units and a control apparatus are separately provided (e.g. industrial robots). This is because, when pluralities of arm units and circuit boards are provided in one casing, with increase of actuators (motors) for driving the arm units, the number of cables connected to the actuators is increased and the boards are upsized, and there is a tendency that these parts are densely packed within the casing. Accordingly, in the robots in which pluralities of arm units and circuit boards are provided in one casing, a technology that enables efficient arrangement of the boards within the casing is required.

Further, in the robots of related art, downsizing, cost reduction, improvement in usability are desired.

### SUMMARY

An advantage of some aspects of the invention is to solve at least a part of the problems described above, and the invention can be implemented as the following forms.

(1) An aspect of the invention provides a robot. The robot includes a casing, a first arm unit and a second arm unit provided on the casing, a first board that outputs a current command signal, a second board that controls an actuator for driving the first arm unit based on the current command signal, and a third board that controls an actuator for driving the second arm unit based on the current command signal, wherein the second board and the third board are provided inside of the casing. According to the robot of this aspect, the boards that control the actuators for driving the arm units are provided with respect to each arm unit. Therefore, the boards may be efficiently arranged within the casing.

(2) In the robot according to the aspect, the first board may be provided inside of the casing. According to the robot of this aspect, the board for outputting the current command signal is also provided apart from the other boards within the casing, and thereby, the boards may be more efficiently arranged within the casing.

(3) In the robot according to the aspect, the casing may have a torso part on which the first arm unit and the second arm are provided, and a base part having the second board and the third board inside. According to the robot of this aspect, the arm units and the boards may be separated, and thereby, the influence of noise generated from the arm units on the boards may be suppressed.

(4) In the robot according to the aspect, the torso part may be rotatable with respect to the base part, and the second board or the third board may control an actuator for rotating the torso part based on the current command signal. According to the robot of this aspect, the second board or the third board may control not only the arm units but also the actuator for rotating the torso part.

(5) In the robot according to the aspect, the torso part can move closer to and away from the base part, and the second board or the third board may control an actuator for moving the torso part closer and away based on the current command signal. According to the robot of this aspect, the second board or the third board may control not only the arm units but also the actuator for moving the torso part closer and away.

(6) In the robot according to the aspect, the torso part may be rotatable with respect to the base part, the torso part can move closer to and away from the base part, the second board may control an actuator for rotating the torso part based on the current command signal, and the third board may control an actuator for moving the torso part closer and away based on the current command signal. According to the robot of this aspect, the second board may control not only the first arm unit but also the actuator for rotating the torso part, and the third board may control not only the second arm unit but also the actuator for moving the torso part closer and away.

The invention can be implemented in other various aspects than the aspect as the robot. For example, the invention may be implemented in aspects of a control apparatus for controlling a robot, a robot system including a robot and a control apparatus, etc.

### BRIEF DESCRIPTION OF THE DRAWINGS

The invention will be described with reference to the accompanying drawings, wherein like numbers reference like elements.

FIG. 1 is an explanatory diagram showing a schematic configuration of a robot system.

FIG. 2 is an explanatory diagram showing a detailed configuration of a control apparatus.

FIG. 3 shows a detailed configuration of a second board.

FIG. 4 is an explanatory diagram showing a functional block implemented by the control apparatus.

### DESCRIPTION OF EXEMPLARY EMBODIMENTS

### (A) Embodiment

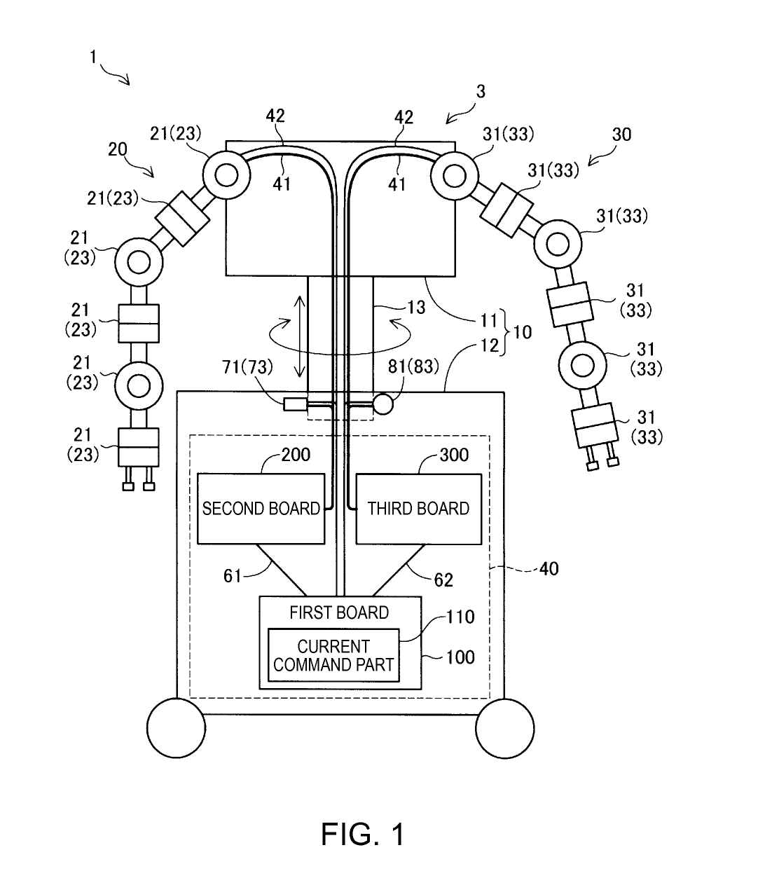

FIG. 1 is an explanatory diagram showing a schematic configuration of a robot system as the first embodiment of the invention. A robot system 1 includes a robot 3 and a control apparatus 40. The robot 3 includes a casing 10, a first arm unit 20, and a second arm unit 30. The first arm unit 20 and the second arm unit 30 are provided on the casing 10. The control apparatus 40 includes a first board 100, a second board 200, and a third board 300. The control apparatus 40 is provided within the casing 10. That is, the casing 10 of the robot 3 of the embodiment includes the first arm unit 20, the second arm unit 30, the first board 100, the second board 200, and the third board 300.

The casing 10 includes a torso part 11 and a base part 12. The torso part 11 includes the first arm unit 20 and the second arm unit 30. The base part 12 includes the control apparatus 40. The torso part 11 and the base part 12 are connected by a connecting member 13. The torso part 11 may rotate around the connecting member 13 with respect to the base part 12. Further, the torso part 11 may move closer to or away from the base part 12 by rise and fall of the connecting member 13 in the vertical direction.

The first arm unit 20 and the second arm unit 30 respectively have six shafts (joint shafts). For the respective shafts provided in the first arm unit 20, actuators 21 for driving the shafts are individually provided. Further, for the respective shafts provided in the second arm unit 30, actuators 31 for driving the shafts are individually provided. In the embodiment, motors are used as the actuators 21, 31. The respective actuators 21 provided in the first arm unit 20 individually include encoders 23 for detection of the rotation angles of the actuators 21. Further, the respective actuators 31 provided in the second arm unit 30 individually include encoders 33 for detection of the rotation angles of the actuators 31.

Within the control apparatus 40 (casing 10), the first board 100 and the second board 200 are connected by a transmission cable 61. Further, the first board 100 and the third board 300 are connected by a transmission cable 62. From the first board 100 to the second board 200 and the third board 300, current command signals are transmitted through these transmission cables 61, 62. In the embodiment, optical cables are used as the transmission cables 61, 62. As the transmission cables 61, 62, not only the optical cables but also other cables (e.g. copper wires) may be used. The current command signals are signals for specifying current values of the currents supplied to the respective actuators.

The second board 200 is connected to the respective actuators 21 provided in the first arm unit 20 via drive cables 41. The third board 300 is connected to the respective actuators 31 provided in the second arm unit 30 via drive cables 41. The first board 100 is connected to the respective encoders 23, 33 provided in the first arm unit 20 and the second arm unit 30 via encoder cables 42. Drive power is supplied to the respective actuators 21, 31 from the second board 200 or the third board 300 via the drive cables 41. From the respective encoders 23, 33, signals indicating the rotation angles of the corresponding shafts are transmitted to the first board 100 via the encoder cables 42. The drive cables 41 and the encoder cables 42 are connected from the respective arm units to the respective boards within the base part 12 through the torso part 11 and the connecting member 13. Note that, in FIG. 1, for convenience of illustration, two of the drive cables 41 and the encoder cables 42 are respectively shown. However, the drive cables 41 are provided in the number corresponding to the number of all actuators provided in the robot 3, and the encoder cables 42 are provided in the number corresponding to the number of all encoders provided in the robot 3.

The first board 100 outputs the current command signals for controlling the respective actuators 21 provided in the first arm unit 20 to the second board 200 through the transmission cable 61. Further, the second board 100 outputs the current command signals for controlling the respective actuators 31 provided in the second arm unit 30 to the third board 300 through the transmission cable 62. The current command signals are generated by a current command part 110 provided on the first board 100. The current command part 110 includes e.g. an FPGA (field programmable array). The second board 200 drives the respective actuators 21 provided in the first arm unit 20 in response to the current command signals received from the first board 100. The third board 300 drives the respective actuators 31 provided in the second arm unit 30 in response to the current command signals received from the first board 100. That is, in the robot 3 of the embodiment, for each arm unit, one board (second board 200, third board 300) for driving the arm unit is provided.

The robot 3 of the embodiment further includes a rotation actuator 71 for rotating the torso part 11 with respect to the base part 12 and a lifting actuator 81 for moving up and down the torso part 11 with respect to the base part 12 in the base part 12. In the embodiment, motors are used as the actuators 71, 81. The rotation actuator 71 includes an encoder 73 for detection of the rotation angle of the rotation actuator 71. The lifting actuator 81 includes an encoder 83 for detection of the rotation angle of the lifting actuator 81. These actuators 71, 81 and encoders 73, 83 are connected to the control apparatus 40 via the drive cables 41 and the encoder cables 42. Note that at least one of the rotation actuator 71 and the lifting actuator 81 may be provided in the connecting member 13 or the torso part 11.

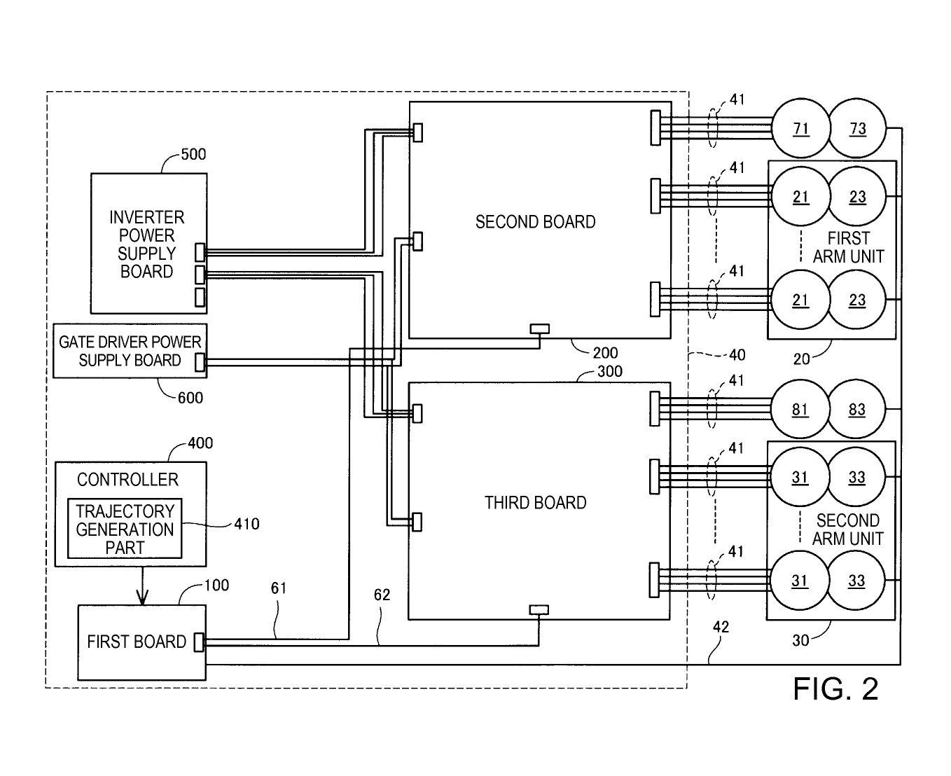

FIG. 2 is an explanatory diagram showing a detailed configuration of the control apparatus. As described above, the control apparatus 40 includes the first board 100, the second board 200, and the third board 300. In the embodiment, in addition to these boards, the control apparatus 40 further includes a controller 400, an inverter power supply board 500, and a gate driver power supply board 600.

The controller 400 is formed as a computer including a CPU and a memory. The CPU operates as a trajectory generation part 410 by executing a predetermined program stored in the memory. The trajectory generation part 410 transmits a position command signal to the current command part 110 of the first board 100 based on trajectory data stored in the memory. In the current command part 110, a current command signal is generated based on the position command signal transmitted from the controller 400. Note that the trajectory generation part 410 may be formed by a circuit. Further, at least one of the controller 400 and the first board 100 may be provided outside of the casing 10.

The inverter power supply board 500 and the gate driver power supply board 600 are respectively connected to the second board 200 and the third board 300. The inverter power supply board 500 is a board for supplying power to inverters (their details will be described later) provided on the second board 200 and the third board 300. The gate driver power supply board 600 is a board for supplying power to gate drivers (their details will be described later) provided on the second board 200 and the third board 300. At least one of the inverter power supply board 500 and the gate driver power supply board 600 may be provided outside of the casing 10.

The pluralities of drive cables 41 are respectively connected to the second board 200 and the third board 300. The respective drive cables 41 are respectively connected to the corresponding actuators 21, 31 of the first arm unit 20 and the second arm unit 30. In the embodiment, the rotation actuator 71 is connected to the second board 200 via the drive cable 41. Further, in the embodiment, the lifting actuator 81 is connected to the third board 300 via the drive cable 41. That is, in the embodiment, the second board 200 controls not only the actuators 21 provided in the first arm unit 20 but also the rotation actuator 71 for rotating the torso part 11. Further, in the embodiment, the third board 300 controls not only the actuators 31 provided in the second arm unit 30 but also the lifting actuator 81 for moving up and down the torso part 11. The respective encoders 23, 33, 73, 83 provided in the respective actuators 21, 31, 71, 81 are individually connected to the first board 100 by the encoder cables 42.

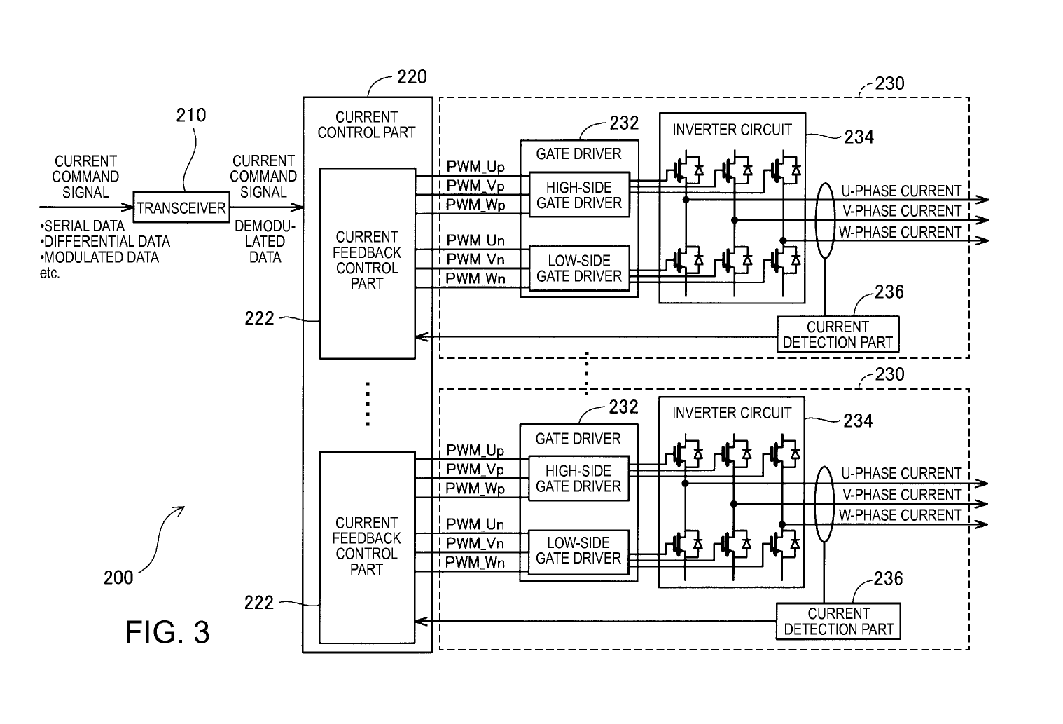

FIG. 3 shows a detailed configuration of the second board 200. The second board 200 and the third board 300 have the same configuration and the explanation of the detailed configuration of the third board 300 will be omitted. The second board 200 includes one transceiver 210, one current control part 220, and a plurality of inverter modules 230. The number of inverter modules 230 provided on the second board 200 is the same as the number of actuators controlled by the second board 200. Namely, in the embodiment, the seven inverter modules 230 are provided on the second board 200.

The transceiver 210 is a circuit that receives the current command signal transmitted from the first board 100 through the transmission cable 61 and demodulates the signal. The current command signal is transmitted from the first board 100 as e.g. serial data, differential data, or modulated data. The transceiver 210 demodulates and transfers the signal to the current control part 220.

The current control part 220 includes current feedback control parts 222 in the same number as that of the inverter modules 230. When receiving the current command signal from the transceiver 210, the current control part 220 separates the current command signal into signals with respect to each actuator, and transmits the signals to the current feedback control parts 222 prepared with respect to each actuator. Each current feedback control part 222 current-feedback-controls the corresponding inverter module 230 in response to the current command signal received from the transceiver 210. In the embodiment, the current control part 220 is formed by one FPGA (field programmable gate array). Note that the current control part 220 may be formed by another IC or circuit, not the FPGA.

The inverter module 230 includes a gate driver 232, an inverter circuit 234, and a current detection part 236. The inverter module 230 drives the inverter circuit 234 by the gate driver 232 based on the control by the current feedback control part 222 to generate and output a three-phase alternating current to the corresponding actuator 21. The current detection part 236 detects a current value of the output three-phase alternating current, and feeds back the value to the current feedback control part 222 of the current control part 220.

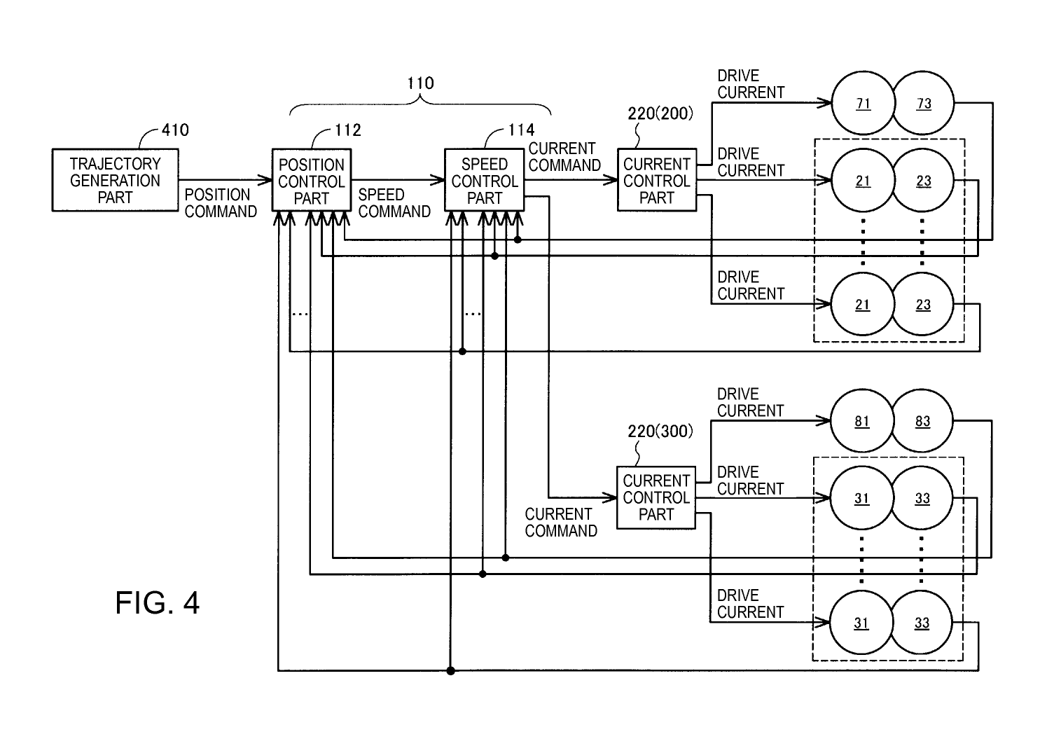

FIG. 4 is an explanatory diagram showing a functional block implemented by the control apparatus 40. As shown in FIG. 4, according to the configuration of the control apparatus 40 of the embodiment, the position command signal output from the trajectory generation part 410 of the controller 400 is converted into a speed command signal by a position control part 112 contained in the current command part 110 provided on the first board 100, and further converted into a current command signal by a speed control part 114 contained in the current command part 110. The current command signal is transmitted to the current control part 220 provided on the second board 200 and the current control part 220 provided on the third board 300. The respective current control parts 220 output drive currents to the respective actuators 21, 31, 71, 81 based on the current command signals received from the first board 100. The current command part 110 (the position control part 112 and the speed control part 114) receives the signals indicating the rotation angles from the encoders 23, 33, 73, 83 provided in the respective actuators 21, 31, 71, 81 as feedback signals, and feedback-controls the speed command signal and the current command signal based on the signals. In this regard, the current command part 110 (the position control part 112 and the speed control part 114) generates the current command signal in response to the feedback signals from the respective encoders so that the first arm unit 20 and the second arm unit 30 may operate in a cooperated manner.

In the above described embodiment, for the first arm unit 20 and the second arm unit 30, the respective boards (the second board 200 and the third board 300) for driving the units are individually provided in the robot 3. Accordingly, the degree of freedom of arrangement of the boards within the casing 10 may be made higher than that in the case where a board common among a plurality of arm units is used for the boards for driving the arm units, and the volume occupied by the entire of boards and the number of wires may be made smaller than those in the case where one board is prepared for each actuator. As a result, according to the embodiment, the respective boards may be efficiently arranged within the casing 10 with balance in all aspects of size, cost, maintenance at attachment and detachment of boards, heat dissipation, etc. Further, in the embodiment, only one board may be provided for each arm unit, and another arm unit may be easily added.

Further, according to the embodiment, the first board 100 that outputs the current command signal is separated from the boards (the second board 200 and the third board 300) for controlling the arm units, and thereby, the boards may be arranged within the casing 10 more efficiently. Furthermore, in the embodiment, the first board 100 is separated from the second board 200 and the third board 300, and noise transmission from the second board 200 and the third board 300 including the inverter circuits to the first board 100 may be suppressed. Moreover, in the embodiment, the optical cables are employed as the transmission cables connecting the second board 200 and the third board 300 to the first board 100, and thereby, the influence of noise from the second board 200 and the third board 300 on the first board 100 may be suppressed more effectively.

Further, in the embodiment, the casing 10 is separated into the torso part 11 and the base part 12, and thereby, the influence of noise generated from the arm units provided on the torso part 11 on the respective boards within the base part 12 may be suppressed.

Furthermore, the second board 200 and the third board 300 in the embodiment have configurations that can respectively control the seven actuators, and, on the other hand, the first arm unit 20 and the second arm unit 30 respectively have the six actuators. Accordingly, the second board 200 and the third board 300 respectively have extra single functions of controlling the actuators. However, in the above described embodiment, the extra functions are respectively used for driving the rotation actuator 71 and the lifting actuator 81. Thus, according to the embodiment, the functions that the second board 200 and the third board 300 originally have may be thoroughly utilized.

### B. Modified Examples

### Modified Example 1

In the above described embodiment, the rotation actuator 71 is controlled by the second board 200 and the lifting actuator 81 is controlled by the third board 300. In this regard, the rotation actuator 71 and the lifting actuator 81 may be controlled by the same board of the second board 200 and the third board 300. In addition, the rotation actuator 71 and the lifting actuator 81 may be controlled by another board than the second board 200 and the third board 300.

### Modified Example 2

In the robot 3 of the above described embodiment, the torso part 11 can make movements of rotation and rise and fall with respect to the base part 12. In this regard, in the robot 3, one or both of the rotation and the rise and fall may be impossible. Namely, at least one of the rotation actuator 71 and the lifting actuator 81 may be omitted. When both the rotation actuator 71 and the lifting actuator 81 are omitted, the casing 10 of the robot 3 are not necessarily separated into the torso part 11 and the base part 12. Further, the robot 3 may include an actuator for driving wheels for movement in the horizontal direction.

### Modified Example 3

The robot 3 of the above described embodiment respectively has the six shafts in the first arm unit 20 and the second arm unit 30. In this regard, the first arm unit 20 and the second arm unit 30 may have seven or more shafts or five or less shafts. Further, the first arm unit 20 and the second arm unit 30 may have different numbers of shafts.

### Modified Example 4

The robot 3 of the above described embodiment has the two arm units (the first arm unit 20 and the second arm unit 30). In this regard, the robot 3 may have three or more arm units.

### Modified Example 5

In the above described embodiment, the motors are used as the actuators for driving the respective shafts, however, other actuators may be used. For example, actuators that drive the respective joints by fluid pressure maybe used.

The invention is not limited to the above described embodiment and modified examples and may be implemented in various configurations without departing from the scope of the invention. For example, the technical features in the embodiment and the modified examples corresponding to the technical features in the respective configurations described in SUMMARY may be appropriately replaced and combined for solving part or all of the above described problems or achieving part or all of the above described advantages. Further, the technical features may be appropriately deleted without their explanation as essentials in the specification.

The entire disclosure of Japanese Patent Application No. 2014-200249, filed Sep. 30, 2014 is expressly incorporated by reference herein.

What is claimed is:

1. A robot comprising:
a casing;
a first arm unit and a second arm unit provided on the casing;
a first board that outputs a current command signal;
a second board that controls an actuator for driving the first arm unit based on the current command signal; and
a third board that controls an actuator for driving the second arm unit based on the current command signal, wherein the second board and the third board are provided inside of the casing.

2. The robot according to claim 1, wherein the first board is provided inside of the casing.

3. The robot according to claim 1, wherein the casing has:
a torso part in which the first arm unit and the second arm are provided; and
a base part having the second board and the third board inside.

4. The robot according to claim 3, wherein the torso part is rotatable with respect to the base part, and
the second board or the third board controls an actuator for rotating the torso part based on the current command signal .

5. The robot according to claim 3, wherein the torso part can move closer to and away from the base part, and
the second board or the third board controls an actuator for moving the torso part closer and away based on the current command signal.

6. The robot according to claim 3, wherein the torso part is rotatable with respect to the base part,
the torso part can move closer to and away from the base part,
the second board controls an actuator for rotating the torso part based on the current command signal, and
the third board controls an actuator for moving the torso part closer and away based on the current command signal.

7. A control apparatus that controls a robot having a casing on which a first arm unit and a second arm unit are provided, comprising:
a first board that outputs a current command signal;
a second board that controls an actuator for driving the first arm unit based on the current command signal; and
a third board that controls an actuator for driving the second arm unit based on the current command signal,
wherein the second board and the third board are provided inside of the casing.

8. A robot system comprising:
a robot; and
a control apparatus,
the robot including
a casing, and
a first arm unit and a second arm unit provided on the casing,
the control apparatus including
a first board that outputs a current command signal,
a second board that controls an actuator for driving the first arm unit based on the current command signal, and
a third board that controls an actuator for driving the second arm unit based on the current command signal,
wherein the second board and the third board are provided inside of the casing.
